(19) United States
(12) Patent Application Publication
(10) Pub. No.: US 2017/0045660 A1
(43) Pub. Date: Feb. 16, 2017

(54) OPTIC FIBER BACKLIGHT MODULE AND LIQUID CRYSTAL DISPLAY DEVICE

(71) Applicant: Shenzhen China Star Optoelectronics Technology Co., Ltd., Shenzhen City (CN)

(72) Inventor: Min TANG, Shenzhen City (CN)

(21) Appl. No.: 14/758,958

(22) PCT Filed: Apr. 22, 2015
(86) PCT No.: PCT/CN2015/077154

§ 371 Date: Jul. 1, 2015

(30) Foreign Application Priority Data
Mar. 24, 2015 (CN) 201510130725.7

(51) Int. Cl. F21V 8/00; G02B 6/04; G02F 1/1335

(52) U.S. Cl. CPC G02B 6/001; G02B 6/0006; G02F 1/133528; G02F 1/133504; G02F 1/133621; G02B 6/04

(57) ABSTRACT

The present invention provides an optic fiber backlight module and a liquid crystal display. The optic fiber backlight module includes a back board, red, green, and blue LED light sources that are set at one side edge of the back board and sequentially arranged, a plurality of groups of optic fiber arranged on the back board, and a prism plate arranged above the plurality of groups of optic fibers, the back board comprising a plurality of recessed grooves formed therein and parallel to and equally spaced from each other, the plurality of groups of optic fibers being respectively set in the plurality of recessed grooves, each group of optic fibers comprising red, green, and blue optic fibers, the red, green, and blue optic fibers being respectively connected through couplers to the red, green, and blue LED light sources so as to provide a surface light source that supplies three primary colors of red, green, and blue to the liquid crystal panel, whereby the liquid crystal panel may realize color displaying without color filters; light transmittance is increased; and color saturation of the liquid crystal display is enhanced.

### BACKGROUND OF THE INVENTION

1. Field of the Invention

The present invention relates to the field of display technology, and in particular to an optic fiber backlight module and a liquid crystal display device.

2. The Related Arts

Liquid crystal displays (LCDs) have a variety of advantages, such as thin device body, low power consumption, and being free of radiation, and are thus used widely, such as mobile phones, personal digital assistants (PDAs), digital cameras, computer monitors, and notebook computer screens.

Most of the LCDs that are currently available in the market are backlighting LCDs, which comprise a backlight module and a liquid crystal panel arranged on the enclosure. The conventional liquid crystal panels are of a structure that comprises a color filter (CF) substrate, a thin-film transistor (TFT) array substrate, and a liquid crystal layer arranged between the two substrates and the principle of operation is that a drive voltage is applied to the two glass substrates to control liquid crystal molecules of the liquid crystal layer to rotate in order to refract out light from the backlight module to generate an image. Since the liquid crystal panel is not self-luminous, light supplied from the backlight module is necessary for normally displaying an image. Thus, the backlight module is one of the key components of a liquid crystal display.

The backlight modules can be classified as side-edge backlight modules and direct backlight modules, according to the site where light gets incident. The direct backlight modules comprise a light source, such as a cold cathode fluorescent lamp (CCFL) or a light-emitting diode (LED), which is arranged at the backside of the liquid crystal panel to directly form a planar light source supplied to the liquid crystal panel. The side-edge backlight modules comprise an LED light bar, serving as a backlight source, which is arranged at an edge of a backplane to be located rearward of one side of the liquid crystal panel. The LED light bar emits light that enters a light guide plate (LGP) through a light incident face at one side of the light guide plate and is projected out of a light emergence face of the light guide plate, after being reflected and diffused, to pass through an optic film assembly so as to form a planar light source for the liquid crystal panel. The liquid crystal panel must be used in combination with the color filter arranged on the CF substrate in order to realize color displaying. The CF substrate is generally for providing three primary colors of red, green, and blue, which generally need thee types of photoresist including red, green, and blue and three rounds of photolithographic operations and of which the average light transmittance is around 30%. The processes adopted for the manufacture of the color filters are generally complicated and the expenditure of the manufacturing machines is high. In addition, the red, green, and blue photoresists are expensive and the utilization of light is low.

Optic fibers are a measure of light transmission, which is achieved based on the principle of total internal reflection of light in the fibers made of glass or plastics. The optic fibers have various advantages including broad waveband, low loss, light weight, good resistance against interference, and high reliability and are widely used in signal transmission for cable televisions and communication industry. The progress of the optic fiber technology allows the optic fibers to be used in the optoelectronic display industry by having some optic fibers subjected to a laser based manufacturing process or other techniques that remove the outer jackets of the optic fibers. Heretofore, applications of optic fibers to backlighting sources have been proposed in certain patent documents. Some are provided for the purposes of improving homogeneity of the backlighting source and utilization of light, or to allow the light and heat sources to be distant from a liquid crystal panel to achieve a bettered effect of heat dissipation. However, these backlighting sources still need to be used in combination with the color filters provided on a CF substrate to realize color displaying. This does not provide a solution to overcome the issue of low utilization of light resulting from the use of color filters.

### SUMMARY OF THE INVENTION

An object of the present invention is to provide an optic fiber backlighting module, which provides planar light sources of three primary colors of red, green, and blue to a liquid crystal panel so that color displaying can be realized with the liquid crystal panel without color filters and which also helps increase light transmittance and increase color saturation of the liquid crystal display.

Another object of the present invention is to provide a liquid crystal display, which comprises an optic fiber backlight module to supply a light source, so that a liquid crystal panel can realize color displaying without color filters and may effectively increase light transmittance and achieves increased color saturation.

To achieve the above objects, the present invention provides an optic fiber backlight module, which comprises a back board, red, green, and blue light-emitting diode (LED) light sources that are set at one side edge of the back board and sequentially arranged, a plurality of groups of optic fiber arranged on the back board, and a prism plate arranged above the plurality of groups of optic fibers. The back board comprises a plurality of recessed grooves formed therein and parallel to and equally spaced from each other. The plurality of groups of optic fibers is respectively set in the plurality of recessed grooves. Each group of optic fibers comprises red, green, and blue optic fibers, the red, green, and blue optic fibers are respectively connected through couplers to the red, green, and blue LED light sources.

The recessed grooves have an arc cross-section and the recessed grooves each have a groove surface coated with a reflective film. Each of the recessed grooves receives and holds therein one of the optic fibers.

Each group of optic fibers comprises three optic fibers and light emitting from the red, green, and blue LED light sources is transmitted through the red, green, and blue optic fibers and projecting outward to form three linear light sources of red, green, and blue colors. The red, green, and blue optic fibers of the plurality of groups are arranged uniformly in a predetermined sequence to form a surface that provides a surface light source in which the three colors of red, green, and blue are arranged to be parallel to and equally spaced from each other.

The prism plate comprises ridge-like prism projections each set above and corresponding to one of the optic fibers so as to have light emitting from left side and right side of the optic fiber substantially parallel to each other.

The present invention also provides a liquid crystal display device, which comprises an optic fiber backlight module, a liquid crystal panel arranged above the optic fiber backlight module, and enclosure resin fixed between the optic fiber backlight module and the liquid crystal panel;

wherein the optic fiber backlight module comprises a back board, red, green, and blue light-emitting diode (LED) light sources that are set at one side edge of the back board and sequentially arranged, a plurality of groups of optic fiber arranged on the back board, and a prism plate arranged above the plurality of groups of optic fibers, the back board comprising a plurality of recessed grooves formed therein and parallel to and equally spaced from each other, the plurality of groups of optic fibers being respectively set in the plurality of recessed grooves, each group of optic fibers comprising red, green, and blue optic fibers, the red, green, and blue optic fibers being respectively connected through couplers to the red, green, and blue LED light sources; and

the liquid crystal panel comprises a plurality of pixels that is arranged in a repeated manner, each of the pixels comprising red, green, and blue sub-pixels, the red, green, and blue optic fibers being arranged to respectively correspond to the red, green, and blue sub-pixels.

The liquid crystal panel comprises a first substrate, a second substrate opposite to the first substrate, enclosure resin fixed between the first substrate and the second substrate, a liquid crystal layer arranged between the first substrate and the second substrate, an upper polarizer arranged on the first substrate, and a lower polarizer arranged under the second substrate.

The upper polarizer comprises a diffuser plate arranged thereon to uniformly spread light emitting from the liquid crystal panel so as to effectively increase the view angle of a liquid crystal display.

The prism plate comprises ridge-like prism projections each set above and corresponding to one of the optic fibers so as to have light emitting from left side and right side of the optic fiber substantially parallel to each other.

Each group of optic fibers comprises three optic fibers and light emitting from the red, green, and blue LED light sources is transmitted through the red, green, and blue optic fibers and projecting outward to form three linear light sources of red, green, and blue colors. The red, green, and blue optic fibers of the plurality of groups are arranged uniformly in a predetermined sequence to form a surface that provides a surface light source in which the three colors of red, green, and blue are arranged to be parallel to and equally spaced from each other.

The recessed grooves have an arc cross-section and the recessed grooves each have a groove surface coated with a reflective film. Each of the recessed grooves receives and holds therein one of the optic fibers.

The present invention further provides a liquid crystal display device, which comprises an optic fiber backlight module, a liquid crystal panel arranged above the optic fiber backlight module, and enclosure resin fixed between the optic fiber backlight module and the liquid crystal panel;

wherein the optic fiber backlight module comprises a back board, red, green, and blue light-emitting diode (LED) light sources that are set at one side edge of the back board and sequentially arranged, a plurality of groups of optic fiber arranged on the back board, and a prism plate arranged above the plurality of groups of optic fibers, the back board comprising a plurality of recessed grooves formed therein and parallel to and equally spaced from each other, the plurality of groups of optic fibers being respectively set in the plurality of recessed grooves, each group of optic fibers comprising red, green, and blue optic fibers, the red, green, and blue optic fibers being respectively connected through couplers to the red, green, and blue LED light sources; and

the liquid crystal panel comprises a plurality of pixels that is arranged in a repeated manner, each of the pixels comprising red, green, and blue sub-pixels, the red, green, and blue optic fibers being arranged to respectively correspond to the red, green, and blue sub-pixels;

wherein the liquid crystal panel comprises a first substrate, a second substrate opposite to the first substrate, enclosure resin fixed between the first substrate and the second substrate, a liquid crystal layer arranged between the first substrate and the second substrate, an upper polarizer arranged on the first substrate, and a lower polarizer arranged under the second substrate; and

wherein the upper polarizer comprises a diffuser plate arranged thereon.

The efficacy of the present invention is that the present invention provides an optic fiber backlight module, which comprises a back board in which a plurality of recessed grooves that are parallel to and equally spaced from each other is formed and the plurality of recessed grooves receives and holds therein a plurality groups of optic fibers, in which each group of optic fibers comprises red, green, and blue optic fibers and the red, green, and blue optic fibers are respectively connected through couplers to red, green, and blue LED light sources to form a surface light source comprising red, green, and blue colors that are parallel to and equally spaced from each other to provide three primary colors of red, green, and blue to the liquid crystal panel, whereby the liquid crystal panel may realize color displaying without color filters; light transmittance is increased; and color saturation of the liquid crystal display is enhanced. A liquid crystal display device according to the present invention comprises an optic fiber backlight module to supply lighting so that the liquid crystal panel may realize color displaying without color filters and light transmittance can be effectively increased; and the optic fiber backlight module may selectively involve different LED light sources of red, green, and blue to provide the liquid crystal panel with a desired color gamut and effectively improve color saturation of the liquid crystal display.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a diagram illustrating the formation of a planar light source with an optic fiber backlight module according to the present invention;

FIG. 2 is a cross-sectional view of the optic fiber backlight module according to the present invention; and

FIG. 3 is a cross-sectional view showing a liquid crystal display device according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

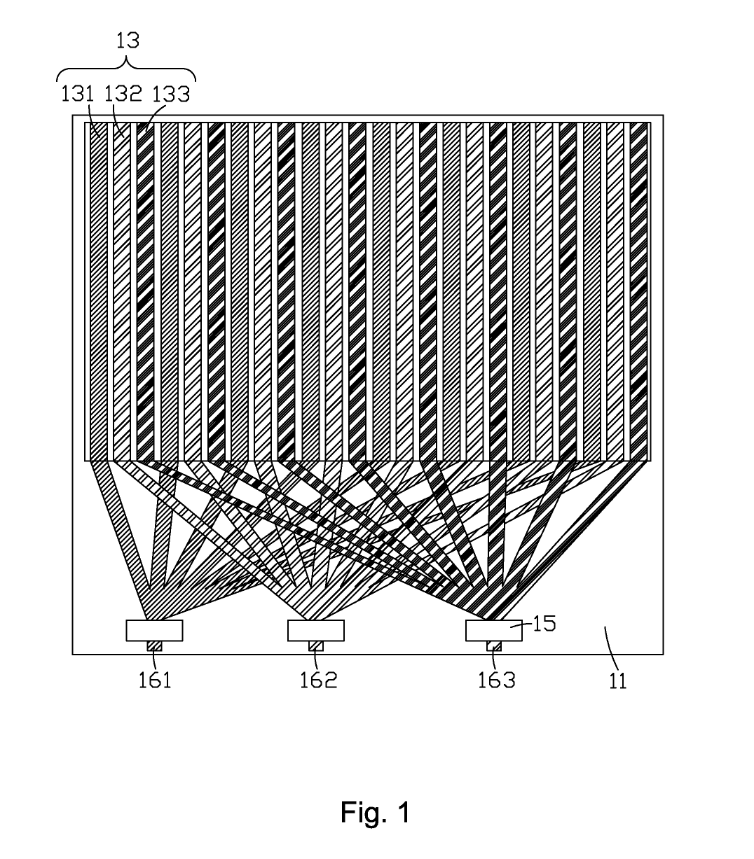

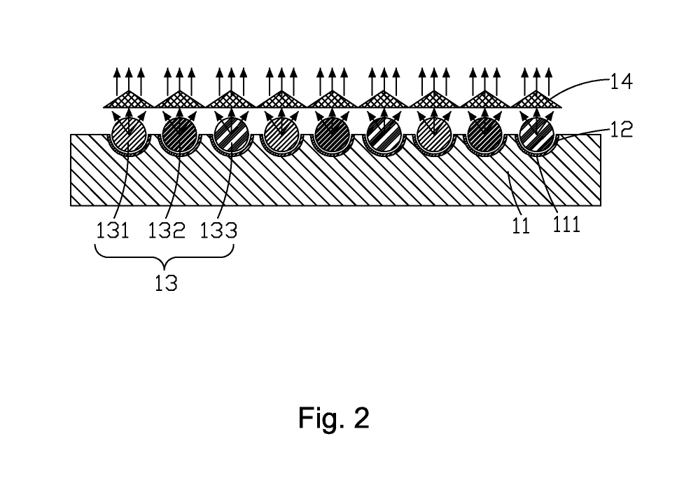

Referring to FIGS. 1 and 2, the present invention provides an optic fiber backlight module, which comprises a back board 11, red, green, and blue LED (Light-Emitting Diode) light sources 161, 162, 163 that are set at one side edge of the back board 11 and sequentially arranged, a plurality of groups of optic fiber 13 arranged on the back board 11, and a prism plate 14 arranged above the plurality of groups of optic fibers 13. The back board 11 comprises a plurality of recessed grooves 111 formed in a top surface thereof and parallel to and equally spaced from each other by a spacing distance. The plurality of groups of optic fibers 13 is respectively set in the plurality of recessed grooves 111. Each group of optic fibers 13 comprises red, green, and blue optic fibers 131, 132, 133 and the red, green, and blue optic fibers 131, 132, 133 are respectively connected through couplers 15 to the red, green, and blue LED light sources 161, 162, 163.

Specifically, in the instant embodiment, the plurality of groups of optic fibers 13 includes at least three groups. In other words, at least three groups of optic fibers 13 are mounted on the back board 11.

Specifically, the optic fibers 131, 132, 133 of the present invention are optic fibers having outer jackets removed so that the condition of total internal reflection of the optic fiber is destructed, whereby light transmitting through the optic fiber is allowed to transmit outward for achieving conversion of a point light source into a linear light source. The measure that is adopted to remove the outer jacket is laser.

Further, each of the recessed grooves 111 comprises one optic fiber 131, 132, or 133 to be received and mounted therein. The recessed groove 111 has a groove surface on which a reflective film 12 may be coated in order to effectively improve utilization of light. Since each group of optic fibers 13 comprises three optic fibers 131, 132, 133 of red, green, and blue and each of the recessed grooves 111 receives one optic fiber to be mounted therein, the number of the recessed grooves 111 formed in the back board 11 is three times of that of the optic fiber groups.

In the instant embodiment, each group of optic fibers 13 comprises three optic fibers and light emitting from the red, green, and blue LED light sources 161, 162, 163 is transmitted through the red, green, and blue optic fibers 131, 132, 133 and then projecting outward to form three linear light sources of red, green, and blue colors. The red, green, and blue optic fibers 131, 132, 133 of the multiplicity of groups are arranged uniformly in a predetermined sequence to form a surface that provides a surface light source in which the three colors of red, green, and blue are arranged to be parallel to and equally spaced from each other. As an alternative option, each group of optic fibers 13 may comprise four optic fibers, such as red, green, blue, and white optic fibers. Specifically, the prism plate 14 is set in direct engagement with the optic fibers 131, 132, 133 and is supported by the optic fibers 131, 132, 133 for the weight thereof. The prism plate 14 comprises ridge-like prism projections each set above and corresponding to one of the optic fibers 131, 132, or 133 so as to have light emitting from left side and right side of the optic fiber substantially parallel to each other to form a uniform planar light source.

Specifically, the recessed grooves 111 have an arc cross-section. The optic fiber backlight module is structured to comprise a plurality of parallel and equally spaced recessed grooves formed in a back board in such a way that the plurality of recessed grooves respectively receives and holds therein a plurality of groups of optic fibers, wherein each of the groups of optic fibers comprises red, green, and blue optic fibers and the red, green, and blue optic fibers are respectively connected through the couplers to red, green, and blue LED light sources for forming a planar light source comprising red, green, and blue colors that are arranged parallel to and equally spaced from each other for providing three primary colors of red, green, and blue to a liquid crystal panel, whereby the liquid crystal panel can realize color displaying without color filters; light transmittance is enhanced; and color saturation of the liquid crystal display is improved.

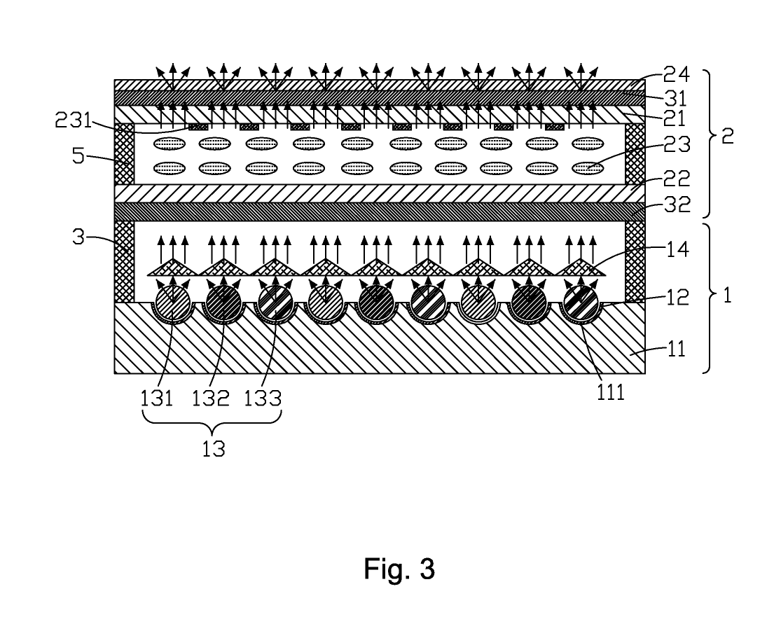

Referring to FIG. 3, in combination with FIGS. 1 and 2, the present invention also provides a liquid crystal display, which comprises an optic fiber backlight module 1, a liquid crystal panel 2 arranged above the optic fiber backlight module 1, and enclosure resin 3 fixed between the optic fiber backlight module 1 and the liquid crystal panel 2.

Specifically, the optic fiber backlight module 1 comprises a back board 11, red, green, and blue LED light sources 161, 162, 163 that are set at one side edge of the back board 11 and sequentially arranged, a plurality of groups of optic fiber 13 arranged on the back board 11, and a prism plate 14 arranged above the plurality of groups of optic fibers 13. The back board 11 comprises a plurality of recessed grooves 111 formed in a top surface thereof and parallel to and equally spaced from each other by a spacing distance. The plurality of groups of optic fibers 13 is respectively set in the plurality of recessed grooves 111. Each group of optic fibers 13 comprises red, green, and blue optic fibers 131, 132, 133 and the red, green, and blue optic fibers 131, 132, 133 are respectively connected through couplers 15 to the red, green, and blue LED light sources 161, 162, 163.

The liquid crystal panel 2 comprises a plurality of pixels that is arranged in a repeated manner. Each of the pixels comprises red, green, and blue sub-pixels that are arranged in sequence. The red, green, and blue optic fibers 131, 132, 133 are arranged to respectively correspond to the red, green, and blue sub-pixels.

Specifically, the liquid crystal panel 2 comprises a first substrate 21, a second substrate 22 opposite to the first substrate 21, enclosure resin 5 fixed between the first substrate 21 and the second substrate 22, a liquid crystal layer 23 arranged between the first substrate 21 and the second substrate 22, an upper polarizer 31 arranged on the first substrate 21, and a lower polarizer 32 arranged under the second substrate 22. Since the optic fiber backlight module 1 forms a planar light source that comprises red, green, and blue colors that are substantially parallel to and equally spaced from each other and may thus provides a planar light source that supplies three primary colors of red, green, and blue to the liquid crystal panel 2, the liquid crystal panel 2 may realize color displaying without any arrangement of color filters.

Further, a black matrix 231 is arranged under the first substrate 21. The black matrix 231 helps block light leakage and prevent light emitting from adjacent ones of the optic fibers 131, 132, 133 of the optic fiber backlight module 1 from overlapping so as to help improve displaying achieved with the liquid crystal display panel 2.

Further, the upper polarizer 31 further comprises a diffuser plate 24 arranged thereon. The diffuser plate 24 helps uniformly and omnidirectionally spread parallel light emitting from the liquid crystal panel 2 to broaden the view angle of the liquid crystal display.

Specifically, in the optic fiber backlight module 1, each of the recessed grooves 111 comprises one optic fiber 131, 132, or 133 to be received and mounted therein. The recessed groove 111 has a groove surface on which a reflective film 12 may be coated in order to effectively improve utilization of light.

Specifically, each group of optic fibers 13 comprises three optic fibers and light emitting from the red, green, and blue LED light sources 161, 162, 163 is transmitted through the red, green, and blue optic fibers 131, 132, 133 and then projecting outward to form three linear light sources of red, green, and blue colors. The red, green, and blue optic fibers 131, 132, 133 of the multiplicity of groups are arranged uniformly in a predetermined sequence to form a surface that provides a planar light source in which the three colors of red, green, and blue are arranged to be parallel to and equally spaced from each other. Further, each group of optic fibers 13 may comprise four optic fibers, such as red, green, blue, and white optic fibers.

Specifically, the prism plate 14 is set in direct engagement with the optic fibers 131, 132, 133 and is supported by the optic fibers 131, 132, 133 for the weight thereof. The prism plate 14 comprises ridge-like prism projections each set above and corresponding to one of the optic fibers 131, 132, or 133 so as to have light emitting from left side and right side of the optic fiber substantially parallel to each other to form a uniform planar light source.

When thin-film transistors (not shown) are conducted on, the liquid crystal layer 23 of the liquid crystal panel 2 is put into operation such that liquid crystal molecules thereof are sequentially arranged by means of alignment films, whereby the planar lighting emitting from the optic fiber backlight module 1 irradiates the liquid crystal layer 23 of the liquid crystal panel 2 and displays desired colors to thereby achieve color displaying.

Specifically, the recessed grooves 111 have an arc cross-section.

Specifically, the liquid crystal panel 2 comprises a mark formed thereon. The prism plate 14 and the back board 11 are both provided with alignment marks. The alignment marks correspond to the mark of the liquid crystal panel 2. To assemble, the prism plate 14 and the back board 11 (with optic fibers 13 received and held in the recessed grooves 111) are assembled together and then, the enclosure resin 3 is coated along a circumference of the back board 11 to allow the liquid crystal panel 2 and the back board 11 to be assembled together. Finally, the enclosure resin 3 is cured to complete the connection between the liquid crystal panel 2 and the optic fiber backlight module 1.

In the above liquid crystal display, an optic fiber backlight module is involved to supply lighting so that the liquid crystal panel may achieve color displaying without color filter. Theoretically, light transmittance can be increased by 300% and the optic fiber backlight module may selectively involve different LED light sources of red, green, and blue to provide a liquid crystal panel with a desired color gamut and effectively improve color saturation of the liquid crystal display.

In summary, the present invention provides an optic fiber backlight module, which comprises a back board in which a plurality of recessed grooves that are parallel to and equally spaced from each other is formed and the plurality of recessed grooves receives and holds therein a plurality groups of optic fibers, in which each group of optic fibers comprises red, green, and blue optic fibers and the red, green, and blue optic fibers are respectively connected through couplers to red, green, and blue LED light sources to form a surface light source comprising red, green, and blue colors that are parallel to and equally spaced from each other to provide three primary colors of red, green, and blue to the liquid crystal panel, whereby the liquid crystal panel may realize color displaying without color filters; light transmittance is increased; and color saturation of the liquid crystal display is enhanced. A liquid crystal display device according to the present invention comprises an optic fiber backlight module to supply lighting so that the liquid crystal panel may realize color displaying without color filters and light transmittance can be effectively increased; and the optic fiber backlight module may selectively involve different LED light sources of red, green, and blue to provide the liquid crystal panel with a desired color gamut and effectively improve color saturation of the liquid crystal display.

Based on the description given above, those having ordinary skills of the art may easily contemplate various changes and modifications of the technical solution and technical ideas of the present invention and all these changes and modifications are considered within the protection scope of right for the present invention.

What is claimed is:

1. An optic fiber backlight module, comprising a back board, red, green, and blue light-emitting diode (LED) light sources that are set at one side edge of the back board and sequentially arranged, a plurality of groups of optic fiber arranged on the back board, and a prism plate arranged above the plurality of groups of optic fibers, the back board comprising a plurality of recessed grooves formed therein and parallel to and equally spaced from each other, the plurality of groups of optic fibers being respectively set in the plurality of recessed grooves, each group of optic fibers comprising red, green, and blue optic fibers, the red, green, and blue optic fibers being respectively connected through couplers to the red, green, and blue LED light sources.

2. The optic fiber backlight module as claimed in claim 1, wherein the recessed grooves have an arc cross-section and the recessed grooves each have a groove surface coated with a reflective film, each of the recessed grooves receiving and holding therein one of the optic fibers.

3. The optic fiber backlight module as claimed in claim 1, wherein each group of optic fibers comprises three optic fibers and light emitting from the red, green, and blue LED light sources is transmitted through the red, green, and blue optic fibers and projecting outward to form three linear light sources of red, green, and blue colors, the red, green, and blue optic fibers of the plurality of groups being arranged uniformly in a predetermined sequence to form a surface that provides a surface light source in which the three colors of red, green, and blue are arranged to be parallel to and equally spaced from each other.

4. The optic fiber backlight module as claimed in claim 1, wherein the prism plate comprises ridge-like prism projections each set above and corresponding to one of the optic fibers so as to have light emitting from left side and right side of the optic fiber substantially parallel to each other.

5. A liquid crystal display device, comprising an optic fiber backlight module, a liquid crystal panel arranged above the optic fiber backlight module, and enclosure resin fixed between the optic fiber backlight module and the liquid crystal panel;
wherein the optic fiber backlight module comprises a back board, red, green, and blue light-emitting diode (LED) light sources that are set at one side edge of the back board and sequentially arranged, a plurality of groups of optic fiber arranged on the back board, and a prism plate arranged above the plurality of groups of optic fibers, the back board comprising a plurality of recessed grooves formed therein and parallel to and equally spaced from each other, the plurality of groups of optic fibers being respectively set in the plurality of recessed grooves, each group of optic fibers comprising red, green, and blue optic fibers, the red, green, and blue optic fibers being respectively connected through couplers to the red, green, and blue LED light sources; and
the liquid crystal panel comprises a plurality of pixels that is arranged in a repeated manner, each of the pixels comprising red, green, and blue sub-pixels, the red, green, and blue optic fibers being arranged to respectively correspond to the red, green, and blue sub-pixels.

6. The liquid crystal display device as claimed in claim 5, wherein the liquid crystal panel comprises a first substrate, a second substrate opposite to the first substrate, enclosure resin fixed between the first substrate and the second substrate, a liquid crystal layer arranged between the first substrate and the second substrate, an upper polarizer arranged on the first substrate, and a lower polarizer arranged under the second substrate.

7. The liquid crystal display device as claimed in claim 5, wherein the upper polarizer comprises a diffuser plate arranged thereon.

8. The liquid crystal display device as claimed in claim 5, wherein the prism plate comprises ridge-like prism projections each set above and corresponding to one of the optic fibers so as to have light emitting from left side and right side of the optic fiber substantially parallel to each other.

9. The liquid crystal display device as claimed in claim 5, wherein each group of optic fibers comprises three optic fibers and light emitting from the red, green, and blue LED light sources is transmitted through the red, green, and blue optic fibers and projecting outward to form three linear light sources of red, green, and blue colors, the red, green, and blue optic fibers of the plurality of groups being arranged uniformly in a predetermined sequence to form a surface that provides a surface light source in which the three colors of red, green, and blue are arranged to be parallel to and equally spaced from each other.

10. The liquid crystal display device as claimed in claim 5, wherein the recessed grooves have an arc cross-section and the recessed grooves each have a groove surface coated with a reflective film, each of the recessed grooves receiving and holding therein one of the optic fibers.

11. A liquid crystal display device, comprising an optic fiber backlight module, a liquid crystal panel arranged above the optic fiber backlight module, and enclosure resin fixed between the optic fiber backlight module and the liquid crystal panel;
wherein the optic fiber backlight module comprises a back board, red, green, and blue light-emitting diode (LED) light sources that are set at one side edge of the back board and sequentially arranged, a plurality of groups of optic fiber arranged on the back board, and a prism plate arranged above the plurality of groups of optic fibers, the back board comprising a plurality of recessed grooves formed therein and parallel to and equally spaced from each other, the plurality of groups of optic fibers being respectively set in the plurality of recessed grooves, each group of optic fibers comprising red, green, and blue optic fibers, the red, green, and blue optic fibers being respectively connected through couplers to the red, green, and blue LED light sources; and
the liquid crystal panel comprises a plurality of pixels that is arranged in a repeated manner, each of the pixels comprising red, green, and blue sub-pixels, the red, green, and blue optic fibers being arranged to respectively correspond to the red, green, and blue sub-pixels;
wherein the liquid crystal panel comprises a first substrate, a second substrate opposite to the first substrate, enclosure resin fixed between the first substrate and the second substrate, a liquid crystal layer arranged between the first substrate and the second substrate, an upper polarizer arranged on the first substrate, and a lower polarizer arranged under the second substrate; and
wherein the upper polarizer comprises a diffuser plate arranged thereon.

12. The liquid crystal display device as claimed in claim 11, wherein the prism plate comprises ridge-like prism projections each set above and corresponding to one of the optic fibers so as to have light emitting from left side and right side of the optic fiber substantially parallel to each other.

13. The liquid crystal display device as claimed in claim 11, wherein each group of optic fibers comprises three optic fibers and light emitting from the red, green, and blue LED light sources is transmitted through the red, green, and blue optic fibers and projecting outward to form three linear light sources of red, green, and blue colors, the red, green, and blue optic fibers of the plurality of groups being arranged uniformly in a predetermined sequence to form a surface that provides a surface light source in which the three colors of red, green, and blue are arranged to be parallel to and equally spaced from each other.

14. The liquid crystal display device as claimed in claim 11, wherein the recessed grooves have an arc cross-section and the recessed grooves each have a groove surface coated with a reflective film, each of the recessed grooves receiving and holding therein one of the optic fibers.
